(19) United States
(12) Patent Application Publication
(10) Pub. No.: US 2013/0082088 A1
(43) Pub. Date: Apr. 4, 2013

(54) METHOD AND APPARATUS FOR REPAIRING A COMPONENT

(71) Applicant: General Electric Company, Schenectady, NY (US)

(72) Inventors: Manish Deepak Dighe, Cincinnati, OH (US); Jonathan Robert Hootman, West Chester, OH (US); John Wladkowski, Lynn, MA (US); Thomas Maria Gartner, Hamburg (DE)

(73) Assignee: General Electric Company, Schenectady, NY (US)

(21) Appl. No.: 13/626,019

(22) Filed: Sep. 25, 2012

Related U.S. Application Data
(60) Provisional application No. 61/541,416, filed on Sep. 30, 2011.

(51) Int. Cl. B23K 20/12

(52) U.S. Cl. 228/112.1; 228/2.1

(57) ABSTRACT

A method for repairing an aircraft component includes removing a portion of the aircraft component to create an opening within the aircraft component. The method also includes creating a patch, inserting the patch into the opening such that a welding location is defined, and coupling the patch to the aircraft component using a friction stir welding process. The friction stir welding process includes inserting a portion of a friction stir welding device into the welding location. The method also includes causing the portion of the friction stir welding device to enter an interior of the patch and removing the portion of the friction stir welding device from the patch at the ramp.

### CROSS-REFERENCE TO RELATED APPLICATIONS

This application claims priority to U.S. Provisional Application No. 61/541,416 filed Sep. 30, 2011 which is hereby incorporated by reference in its entirety.

### BACKGROUND OF THE INVENTION

The present application relates generally to aircraft power systems and, more particularly, to a method and apparatus for use in repairing a component.

At least some aircraft engines are housed within a casing. Such engine casings and/or other components of aircraft engines may be at least partially manufactured from aluminum and/or an aluminum alloy. The casings and/or other aircraft components may experience cracking, corrosion, wear, and/or other damage that may undesirably lessen the useful life of the casings or components.

Repairs may be performed on damaged aircraft components to restore at least a part of the aircraft component's functionality and/or structural integrity. For example, replacement material may be welded onto the component and/or may replace one or more damaged sections of the component. However, at least some known welding processes may degrade the structural integrity of areas surrounding the repaired portion of the component and/or may not restore a desired amount of structural integrity to the component. Other known welding processes may cause excessive distortion, internal defects, and/or voids to be formed within the component.

### BRIEF DESCRIPTION OF THE INVENTION

In one embodiment, a method for repairing an aircraft component is provided that includes removing a portion of the aircraft component to create an opening within the aircraft component. The method also includes creating a patch, inserting the patch into the opening such that a welding location is defined, and coupling the patch to the aircraft component using a friction stir welding process. The friction stir welding process includes inserting a portion of a friction stir welding device into the welding location. The method also includes causing the portion of the friction stir welding device to enter an interior of the patch and removing the portion of the friction stir welding device from the patch at the ramp.

In another embodiment, a repair system for repairing a component including a defective portion is provided. The repair system includes a patch including a ramp. The patch is configured to be inserted within an opening created in the component by removing the defective portion, wherein the opening is bounded by an edge of the component. The repair system also includes a friction stir welding device and a computing device coupled to the friction stir welding device. The computing device is configured to control the friction stir welding device to friction stir weld the patch to the component edge, cause a portion of the friction stir welding device to enter an interior of the patch, and remove the portion of the friction stir welding device from the patch using the ramp.

### BRIEF DESCRIPTION OF THE DRAWINGS

FIG. 1 is a schematic illustration of an exemplary gas turbine engine.

FIG. 2 is a block diagram of an exemplary section of the gas turbine engine shown in FIG. 1.

FIG. 3 is a block diagram of an exemplary repair system that may be used with the gas turbine engine shown in FIG. 1.

FIG. 4 is a perspective view of an exemplary patch that may be used with the repair system shown in FIG. 3.

FIG. 5A is a side view of an exemplary section of the gas turbine engine shown in FIG. 1 and an exemplary patch that may be used during an exemplary friction stir welding process.

FIG. 5B is a top view of an exemplary section of the gas turbine engine shown in FIG. 1 and an exemplary patch that may be used during an exemplary friction stir welding process.

FIG. 5C is a side view of an exemplary patch that may be used during an exemplary friction stir welding process.

FIG. 6 is a flow diagram of an exemplary method for repairing a component that may be used with the gas turbine engine shown in FIG. 1.

### DETAILED DESCRIPTION OF THE INVENTION

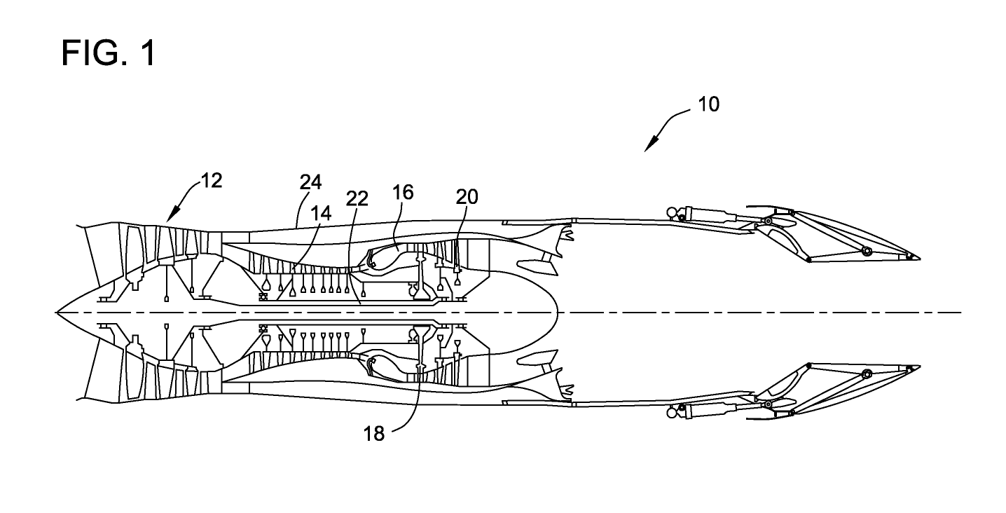

FIG. 1 is a schematic illustration of an exemplary gas turbine engine 10 including a low pressure compressor 12, a high pressure compressor 14, and a combustor 16. Engine 10 also includes a high pressure turbine 18 and a low pressure turbine 20. Compressor 12 and turbine 20 are coupled by a first shaft 21, and compressor 14 and turbine 18 are coupled by a second shaft 22. Gas turbine engine 10 may include one or more electronic controls. Components of gas turbine engine 10 are at least partially enclosed by an engine casing 24. In the exemplary embodiment, engine casing 24 is manufactured from aluminum, an aluminum alloy, and/or any other material that enables casing 24 to function as described herein.

In the exemplary embodiment, gas turbine engine 10 is a gas turbine engine 10 of an aircraft (not shown). Alternatively, gas turbine engine 10 may be used with any other machine, system, or device.

In operation, air flows through low pressure compressor 12 and a portion of that compressed air is channeled to high pressure compressor 14. The highly compressed air is channeled to combustor 16, where it is mixed with fuel and ignited to produce a combustion gas flow that drives turbines 18 and 20.

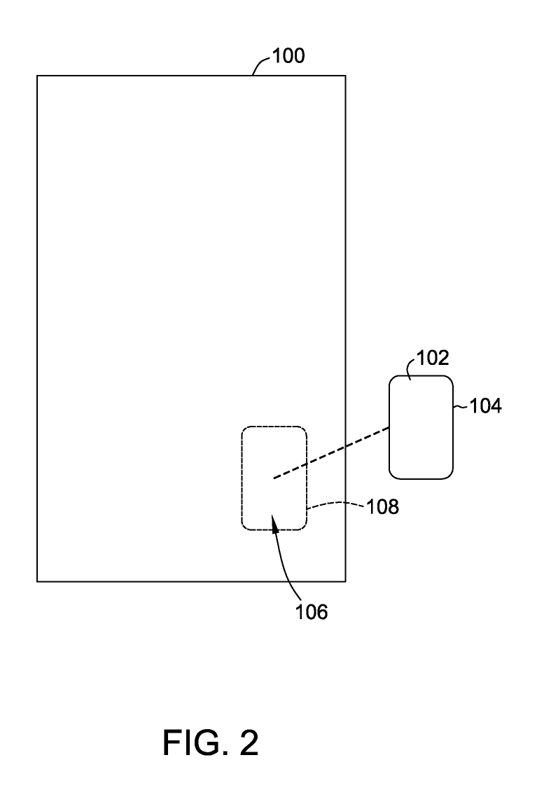

FIG. 2 is a block diagram of an exemplary section 100 of gas turbine engine 10 (shown in FIG. 1). In the exemplary embodiment, section 100 is a portion of engine casing 24 that includes at least one defective portion 102. Alternatively, section 100 is any other portion of gas turbine engine 10, or any other portion of a component of gas turbine engine 10, that has at least one defective portion 102.

In the exemplary embodiment, defective portion 102 is a portion of gas turbine engine 10 (e.g., of section 100), or of a component thereof, that is desirable to be replaced and/or repaired. As used herein, the term “defective” is not limited to only including faults, flaws, or deficiencies within section 100, but may also include a portion that is desired to be removed for reasons other than being faulty. As such, defective portion 102 may include, without limitation, a portion of section 100 that is at least partially corroded, structurally weakened, abraded, worn down, and/or that is otherwise desired to be replaced and/or repaired.

In the exemplary embodiment, a perimeter 104 of defective portion 102 may be identified to facilitate replacing and/or repairing defective portion 102. It should be understood that perimeter 104 may include or encompass material of section 100 that does not need to be replaced and/or repaired. Defective portion 102 is removed, for example, by milling or by another suitable process, along perimeter 104 to create a replacement opening 106 within section 100. More specifically, replacement opening 106 is defined and bounded by a perimeter 108.

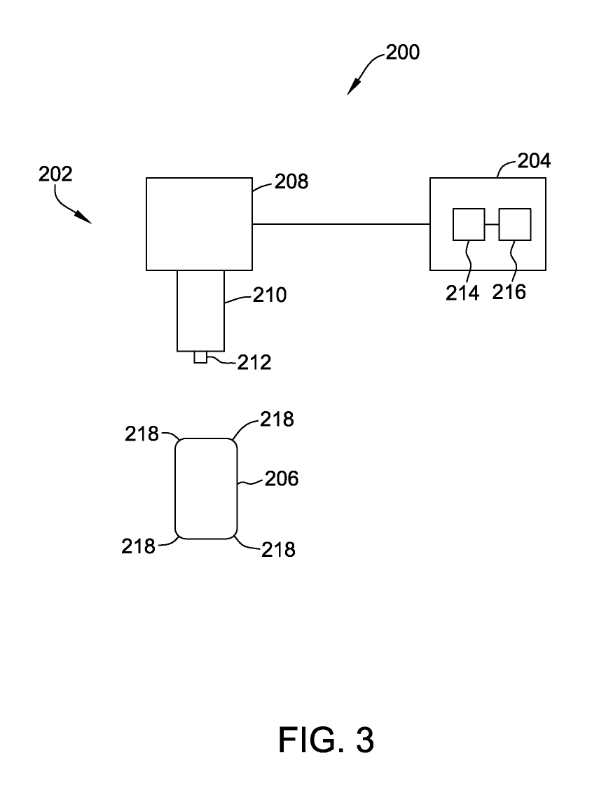

FIG. 3 is a block diagram of an exemplary repair system 200 that may be used with gas turbine engine 10 (shown in FIG. 1). More specifically, repair system 200 may be used to replace and/or repair defective portion 102 (shown in FIG. 2) and/or any other portion of gas turbine engine 10. In the exemplary embodiment, repair system 200 includes a friction stir welding (FSW) device 202, a computing device 204, and a patch 206.

FSW device 202 includes, in the exemplary embodiment, a motor 208, a rotating shoulder 210, and a pin 212. Shoulder 210 is coupled to motor 208, and pin 212 is coupled to shoulder 210. Pin 212 and shoulder are manufactured from a material that is designed to be non-consumable, to withstand the rotational frictional heating and high mechanical loading, and to avoid negative material interaction experienced during a friction stir welding process of defective portion 102 and/or section 100 (shown in FIG. 2) of gas turbine 10.

Computing device 204 is communicatively coupled to FSW device 202 to control an operation of FSW device 202. In the exemplary embodiment, computing device 204 includes at least one processor 214 and at least one memory device 216 coupled to processor 214.

In the exemplary embodiment, processor 214 includes any suitable programmable circuit including one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above examples are exemplary only, and thus are not intended to limit in any way the definition and/or meaning of the term “processor.”

Memory device 216 includes a computer readable medium, such as, without limitation, random access memory (RAM), flash memory, a hard disk drive, a solid state drive, a diskette, a flash drive, a compact disc, a digital video disc, and/or any suitable memory. In the exemplary embodiment, memory device 216 includes data and/or instructions that are executable by processor 214 (i.e., processor 214 is programmed by the instructions) to enable processor 214 to perform the functions described herein. More specifically, in the exemplary embodiment, memory device 216 stores process parameters for controlling FSW device 202, such as a speed of rotation of motor 208, an angle to insert pin 212 into a welding location, a direction and a distance to move FSW device 202 relative to section 100 during one or more welding stages or segments, a speed at which to move FSW device 202 with respect to section 100, a pressure to be applied by FSW device 202, and/or any other parameter that enables FSW device 202 to function as described herein.

Patch 206 is manufactured to replace defective portion 102. Accordingly, in the exemplary embodiment, patch 206 is manufactured from the same or improved material with respect to corrosion resistance, mechanical properties, and dimensional enhancements as the material of section 100 and/or defective portion 102. In the exemplary embodiment, patch 206 includes a lip portion and a ramp (neither shown in FIG. 3) that facilitate enabling patch 206 to be friction stir welded into section 100 to replace and/or repair defective portion 102. Moreover, as illustrated in FIG. 3, patch 206 includes substantially rounded corners 218 to reduce sudden or quick changes of direction when welding around the perimeter of patch 206. Accordingly, a friction stir welding process is facilitated by the rounded corners 218. It should be recognized that perimeter 104 of defective portion 102 and perimeter 108 of replacement opening 106 are also formed with rounded corners such that patch 206 substantially matches the contour of replacement opening 106 and/or defective portion 102.

During operation, computing device 204 controls FSW device 202 to perform a friction stir welding operation or process on section 100. Defective portion 102 is removed from section 100, as described more fully herein, and patch 206 is inserted into replacement opening 106 (shown in FIG. 2) defined in section 100. Based on commands received from computing device 204, motor 208 begins to rotate pin 212 and shoulder 210. Pin 212 and shoulder 210 are inserted into a welding location between and/or proximate to replacement opening perimeter 108 (shown in FIG. 2) and/or patch 206. The rotation of pin 212 causes the material at the welding location (i.e., the material of section 100 and/or patch 206) to heat and plasticize. The rotation of shoulder 210 encapsulates the plasticized material to create fluid flow dynamics that generate a quality weld. As FSW device 202 is moved along the welding location, the plasticized material left behind cools and solidifies to form a weld between section 100 and patch 206. As FSW device 202 completes the weld between section 100 and patch 206, FSW device 202 exits the welding location at the ramp of patch 206, leaving a void or opening generated by the exiting pin 212, as described more fully herein.

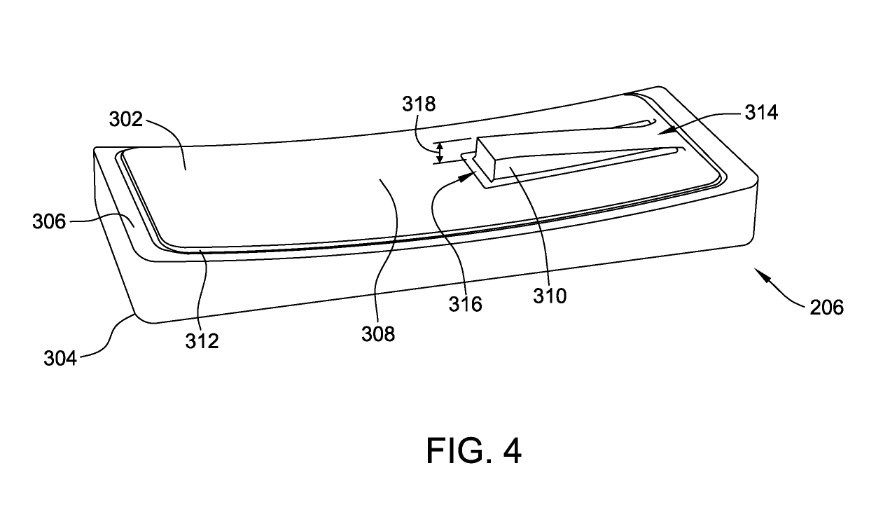

FIG. 4 is a perspective view of an exemplary patch 206 that may be used with repair system 200 (shown in FIG. 3). In the exemplary embodiment, patch 206 is designed and manufactured to replace defective portion 102.

Patch 206 includes an inner surface 302, an outer surface 304, and a lip 306 extending radially outward from inner surface 302 with respect to a center 308 of inner surface 302. Patch 206 also includes a ramp 310 extending at least partially axially outward from inner surface 302 with respect to center 308.

In the exemplary embodiment, inner surface 302 is sized and shaped to substantially match an area and a shape of an inner surface (none shown) of defective portion 102 and/or section 100. Moreover, a perimeter 312 of inner surface 302 is substantially complementary to, or matches, perimeter 104 of defective portion 102 and/or perimeter 108 of replacement opening 106 such that inner surface 302 is substantially flush against an opening formed in section 100 when patch 206 is inserted within replacement opening 106 to replace defective portion 102.

Outer surface 304 is sized and shaped to substantially match an area and a shape of an outer surface (none shown) of defective portion 102 and/or section 100. Moreover, in the exemplary embodiment, the area of outer surface 304 includes the area of inner surface 302 and an area of lip 306 such that outer surface 304 is larger in area than inner surface 302. Lip 306 is axially offset from inner surface 302 a distance toward outer surface 304 such that inner surface 302 is raised with respect to lip 306. Moreover, lip 306 extends across at least a portion of the outer surface of section 100, proximate to replacement opening perimeter 108, when patch 206 is inserted within replacement opening 106.

In the exemplary embodiment, ramp 310 is integrally formed with inner surface 302 and extends axially outward from inner surface 302. More specifically, ramp 310 extends from an entry portion 314 to an exit portion 316. Entry portion 314 is substantially level with inner surface 302, and exit portion 316 extends a height 318 above inner surface 302. In one embodiment, ramp 310 is substantially linear as ramp 310 extends from entry portion 314 to exit portion 316. Alternatively, ramp 310 is substantially curvilinear as ramp 310 extends from entry portion 314 to exit portion 316. In one embodiment, ramp 310 extends from perimeter 312 of inner surface 302 to an interior of patch 206 (e.g., to exit portion 316). In another embodiment, ramp 310 extends from a first point in the interior of patch 206 (e.g., at entry portion 314) to a second point in the interior of patch 206 (e.g., at exit portion 316).

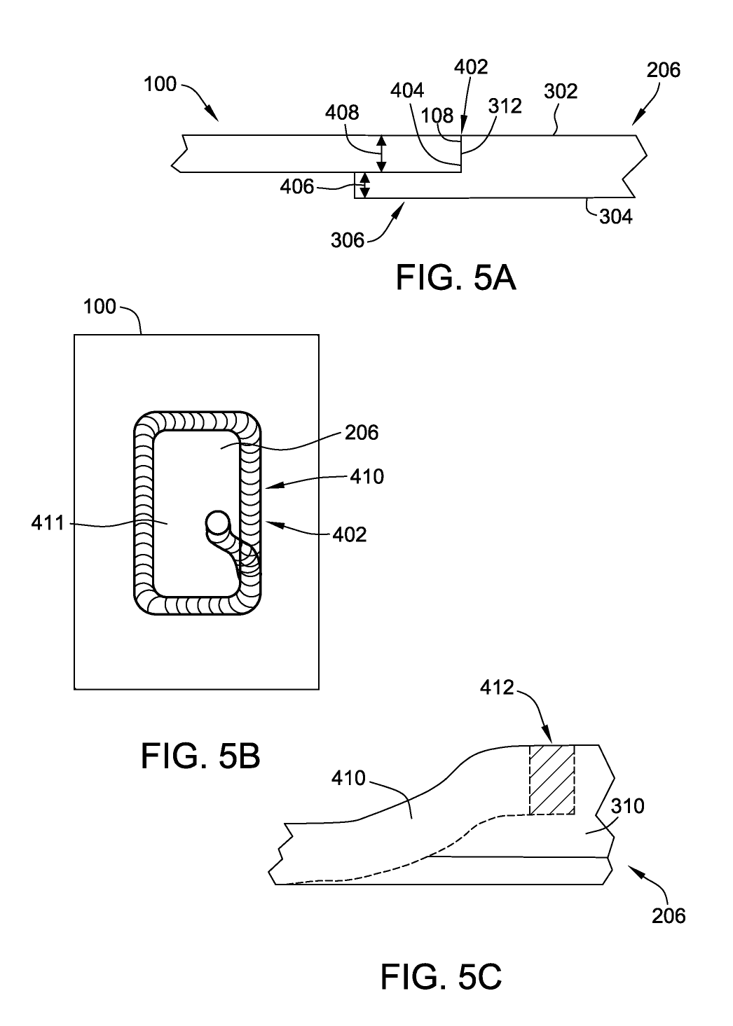

FIG. 5A is a side view of section 100 and patch 206 during an exemplary friction stir welding process. FIG. 5B is a top view of section 100 and patch 206 during an exemplary friction stir welding process. FIG. 5C is a side view of patch 206 at an end of an exemplary friction stir welding process.

As illustrated in FIG. 5A, patch 206 is inserted into replacement opening 106 (shown in FIG. 2) such that inner surface perimeter 312 abuts replacement opening perimeter 108 to define a welding location 402. In the exemplary embodiment, pin 212 of FSW device 202 (both shown in FIG. 3) is inserted into welding location 402 during a friction stir welding operation to weld patch 206 to section 100 along replacement opening perimeter 108.

Moreover, lip 306 overlaps at least a portion of section 100 (hereinafter referred to as a “section edge 404”) proximate to replacement opening perimeter 108. It should be understood that section edge 404 extends along the full perimeter 108 of replacement opening 106. In the exemplary embodiment, lip 306 is manufactured such that a thickness 406 of lip 306 plus a thickness 408 of section edge 404 is equal to a constant value at substantially each location (or at a plurality of locations) along replacement opening perimeter 108 and/or along section edge 404. Accordingly, patch 206 is customized to facilitate welding to a section edge 404 that has a uniform thickness 408, and/or to a section edge 404 having a variable thickness 408 along, or proximate to, replacement opening perimeter 108. In one embodiment, a single patch 206 template may be used with sections 100 and/or section edges 404 of different thickness 408 by removing excess material from patch outer surface 304 after patch 206 has been welded to section 100 and/or section edges 404 to form a weld and/or repaired area of uniform or constant thickness.

As shown in FIGS. 5B and 5C, in the exemplary embodiment, FSW device 202 creates a weld 410 as device 202 travels along welding location 402. FSW device 202 completes one revolution, or substantially one revolution, around welding location 402 (i.e., one revolution around patch 206 and/or replacement opening perimeter 108) before exiting welding location 402. Moreover, FSW device 202 exits welding location 402 proximate to ramp 310 and enters an interior 411 of patch 206. Pin 212 exits patch 206 by travelling up ramp 310 until pin 212 reaches exit portion 316 (shown in FIG. 4). As pin 212 exits patch 206 at ramp exit portion 316, an exit opening 412 is formed in weld 410 by pin 212. By exiting pin 212 at ramp exit portion 316, exit opening 412 is facilitated to be smaller than exit openings formed by prior art systems. Moreover, exit opening 412 is positioned at a location within patch 206 that can be removed during a later manufacturing process. More specifically, exit opening 412 is positioned at ramp exit portion 316 (at height 318 above patch inner surface 302) such that ramp 310 may be removed to eliminate exit opening 412 without affecting weld 410 at welding location 402.

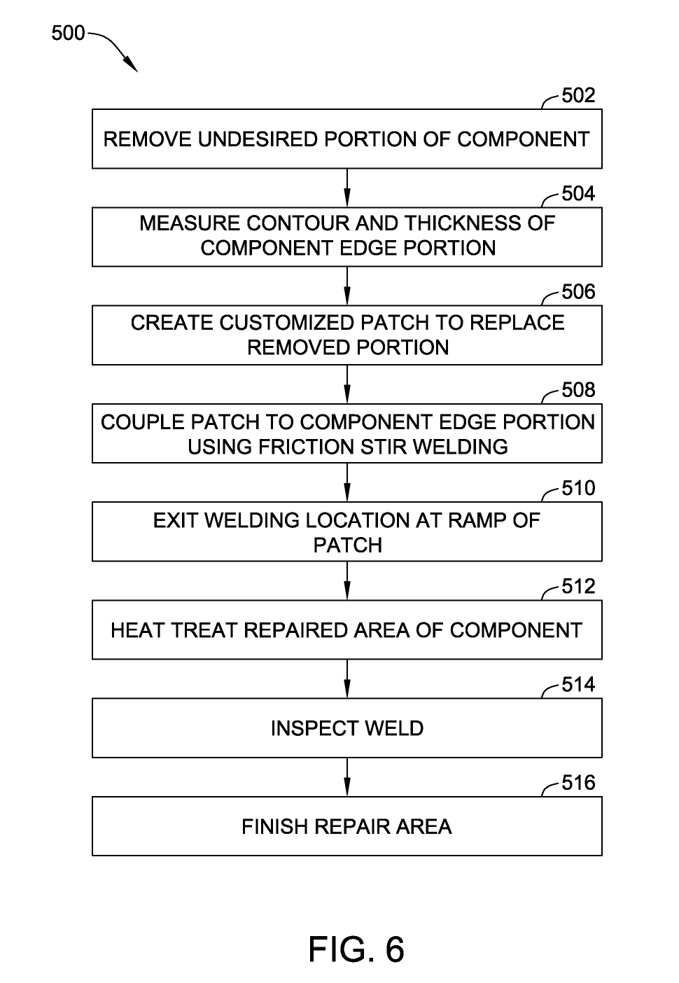

FIG. 6 is a flow diagram of an exemplary method 500 of repairing a component, such as a component or section 100 (shown in FIG. 2) of gas turbine engine 10 (shown in FIG. 1). In the exemplary embodiment, an undesired portion, such as defective portion 102 (shown in FIG. 2) is removed 502 from the component to be repaired, such as section 100. As such, material from section 100 is removed to provide space for new material (e.g., patch 206) to be inserted and/or attached to section 100. In one embodiment, defective portion 102 is removed 502 by milling portion 102 out of section 100 along defective portion perimeter 104. The removal of defective portion 102 creates replacement opening 106 (shown in FIG. 2).

A contour, or perimeter 108, of replacement opening 106, and a thickness 408 of section edge 404 (both shown in FIG. 5A) encompassing replacement opening perimeter 108 are measured 504. A customized patch 206 is created 506 to replace defective portion 102 based on the measured replacement opening perimeter 108 and the measured thickness 408 of section edge 404. More specifically, perimeter 312 of inner surface 302 is formed or adjusted to substantially match replacement opening perimeter 108. Lip 306 is formed or adjusted such that thickness 406 of lip 306 plus thickness 408 of section edge 404 is equal to a constant value at each location along replacement opening perimeter 108.

In the exemplary embodiment, patch 206 is coupled 508 to section edge 404 along replacement opening perimeter 108 using friction stir welding (i.e., by FSW device 202). More specifically, pin 212 of FSW device 202 is inserted into welding location 402 (shown in FIG. 5A) and motor 208 is activated to rotate shoulder 210 (both shown in FIG. 3) and pin 212. The rotation of pin 212 and the friction generated thereby causes the material of section edge 404 and/or patch 206 adjacent to pin 212 to plasticize. In the exemplary embodiment, FSW device 202 completes one revolution, or substantially one revolution, around replacement opening perimeter 108 and welding location 402 to weld patch 206 to section edge 404. FSW device 202 (i.e., pin 212) exits 510 welding location 402 at, or proximate to, ramp 310, and exits patch 206 at exit portion 316 of ramp 310.

In the exemplary embodiment, after patch 206 has been welded to section edge 404, the repaired area (e.g., section edge 404 and patch 206) are locally heat treated 512 to improve the mechanical properties of the friction stir weld while minimizing negative effects on the mechanical properties of the remaining portions of section 100.

Weld 410 and/or welding location 402 are inspected 514, for example, by x-ray, a non-destructive fluorescent penetrant inspection (FPI), and/or any other suitable process to determine the integrity of weld 410. The repaired area is finished 516 or blended to match the remaining portions of section 100. In addition, ramp 310 (and thereby exit opening 412) is removed such that patch inner surface 302 substantially matches other portions of section 100. It should be recognized that because ramp 310 is in the interior of patch 302, the removal of ramp 310 (and exit opening 412) does not affect the structural integrity of weld 410 and/or welding location 402.

A technical effect of the systems and method described herein includes at least one of (a) removing a portion of an aircraft component to create an opening within the aircraft component; (b) creating a patch that includes a ramp; (c) inserting a patch into an opening defined in an aircraft component such that a welding location is defined; (d) coupling a patch to an aircraft component using a friction stir welding process, wherein the friction stir welding process includes inserting a portion of a friction stir welding device into the welding location; (e) causing a portion of a friction stir welding device to enter an interior of a patch; and (f) removing a portion of a friction stir welding device from a patch using a ramp.

The above-described embodiments provide an efficient and cost-effective repair system and method for repairing a component. A friction stir welding (FSW) device is used to weld a patch to an edge of an aircraft component section. The FSW device creates a weld along a welding location between the patch and the edge. The patch includes a ramp that enables the FSW device to exit the welding location into the patch, and exit the patch at the ramp to form an exit opening. Accordingly, the ramp and exit opening can be removed during a later manufacturing operation, thus maintaining the structural integrity of the weld, the patch, and the repaired section of the component.

Exemplary embodiments of a method and apparatus for use in repairing a component are described above in detail. The method and apparatus are not limited to the specific embodiments described herein, but rather, components of the apparatus and/or steps of the method may be utilized independently and separately from other components and/or steps described herein. For example, the method of repair may also be used in combination with other components or structures, and is not limited to practice with only the aircraft gas turbine engine as described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for repairing an aircraft component, said method comprising:
removing a portion of the aircraft component to create an opening within the aircraft component;
creating a patch that includes a ramp;
inserting the patch into the opening such that a welding location is defined;
coupling the patch to the aircraft component using a friction stir welding process, wherein the friction stir welding process comprises inserting a portion of a friction stir welding device into the welding location;
causing the portion of the friction stir welding device to enter an interior of the patch; and
removing the portion of the friction stir welding device from the patch using the ramp.

2. A method in accordance with claim 1, wherein the patch includes a lip and wherein the opening is bounded by an edge portion, said inserting the patch into the opening further comprises overlapping the lip with the edge portion.

3. A method in accordance with claim 1, wherein the friction stir welding device is removed from the patch after the friction stir welding device completes one revolution around the patch.

4. A method in accordance with claim 1, further comprising heat treating at least a portion of the component and the patch after removing the portion of the friction stir welding device from the patch.

5. A method in accordance with claim 1, further comprising inspecting a weld created by the friction stir welding device using at least one of an x-ray and a fluorescent penetrant non-destructive inspection.

6. A method in accordance with claim 1, wherein the patch includes a lip including a thickness and wherein the component includes a thickness, said creating a patch comprises creating a patch such that the lip thickness plus the component thickness equals a constant value at a plurality of locations around a perimeter of the opening when the patch is inserted into the opening.

7. A method in accordance with claim 1, wherein the portion of the aircraft component is removed using a milling process.

8. A method in accordance with claim 1, wherein the friction stir welding device includes a shoulder and a pin coupled to the shoulder, and wherein inserting a portion of the friction stir welding device into the welding location comprises inserting the pin into the welding location.

9. A method in accordance with claim 1, wherein creating a patch comprises creating a patch including a ramp that extends outwardly from an inner surface of the patch.

10. A method in accordance with claim 1, wherein creating a patch comprises creating a patch including rounded corners that substantially conform with the opening created in the aircraft component.

11. A repair system for repairing a component including a defective portion, said repair system comprising:
a patch comprising a ramp, said patch is configured to be inserted within an opening created in the component by removing the defective portion, wherein the opening is bounded by an edge of the component;
a friction stir welding device; and
a computing device coupled to said friction stir welding device, said computing device configured to control said friction stir welding device to:
friction stir weld said patch to the component edge;
cause a portion of said friction stir welding device to enter an interior of said patch; and
remove said portion of said friction stir welding device from said patch using said ramp.

12. A repair system in accordance with claim 11, wherein the opening is bounded by an edge portion and wherein said patch comprises a lip configured to overlap said edge portion when said patch is inserted into the opening.

13. A repair system in accordance with claim 11, wherein said computing device is configured to cause said portion of said friction stir welding device to be removed from said patch after said friction stir welding device completes one revolution around said patch.

14. A repair system in accordance with claim 11, wherein said patch comprises a lip comprising a thickness and the component includes a thickness such that the lip thickness plus the component thickness equals a constant value at a plurality of locations around a perimeter of the opening when said patch is inserted into the opening.

15. A repair system in accordance with claim 11, wherein said friction stir welding device comprises a shoulder and a pin coupled to said shoulder.

16. A repair system in accordance with claim 15, wherein said computing device is configured to cause said pin to be inserted into the welding location to enable said patch to be friction stir welded to the component edge.

17. A repair system in accordance with claim 11, wherein said ramp extends outwardly from an inner surface of said patch.

18. A repair system in accordance with claim 17, wherein said ramp extends from a perimeter of the inner surface to the interior of said patch.

19. A repair system in accordance with claim 17, wherein said ramp extends from a first point in the interior of said patch to a second point in the interior of said patch.

20. A repair system in accordance with claim 11, wherein said patch comprises a plurality of rounded corners that substantially conform with the opening created in the component.
